(19) United States
(12) Patent Application Publication
(10) Pub. No.: US 2016/0191878 A1
(43) Pub. Date: Jun. 30, 2016

(54) IMAGE PROJECTION DEVICE

(71) Applicant: Panasonic Intellectual Property Management Co., Ltd., Osaka (JP)

(72) Inventor: Tomohisa Tagami, Osaka (JP)

(21) Appl. No.: 14/978,636

(22) Filed: Dec. 22, 2015

(30) Foreign Application Priority Data
Dec. 25, 2014 (JP) 2014-263650
Dec. 17, 2015 (JP) 2015-245843

(51) Int. Cl. H04N 9/31

(52) U.S. Cl. CPC H04N 9/3185; H04N 9/3188; H04N 9/317

(57) ABSTRACT

An image projection device according to the present disclosure includes a projection optical unit, a projector for projecting an image that is based on a video signal on a projection target object through the projection optical unit, a detector for detecting a predetermined object from the image indicated by the video signal, and a controller for specifying, based on a position of the detected object in the image, a projection position of the object, and controlling the projection optical unit based on the projection position.

### BACKGROUND

1. Technical Field

The present disclosure relates to an image projection device for projecting and displaying an image on a projection target object.

2. Description of the Related Art

An image projection device is a device for displaying an image by projecting the image on a projection target object such as a screen based on an input video signal. Some image projection devices are provided with an automatic focusing function (see Unexamined Japanese Patent Publication Nos. 2011-242455, 2006-189685, and 2009-075147).

There is a video technique called projection mapping for projecting, by the image projection device, an image created by a computer or the like on a three-dimensional target object such as a building. Projection mapping takes various objects, such as a building, a desk, a chair, a plate, and a tree, as projection targets. Particularly, projection mapping accurately projects an image according to the shape of the target object on which the image is to be projected. Various presentations may be performed by the combination of the shape of the target object itself and the image that is projected.

### SUMMARY

According to one aspect of the present disclosure, there is provided an image projection device including a projection optical unit, a projector for projecting an image that is based on a video signal on a projection target object through the projection optical unit, a detector for detecting a predetermined object from the image indicated by the video signal, and a controller for specifying, based on a position of the detected object in the image, a projection position of the object, and controlling the projection optical unit based on the projection position.

According to the image projection device of the present disclosure, even in a case where a projection target object has moved, in a case where the projection target object is a three-dimensional object, or in a case where an object in a video signal has moved, an image according to which an object is focused on a projection target object and which has a predetermined size may be projected.

### BRIEF DESCRIPTION OF DRAWINGS

FIG. 1 is a diagram showing a configuration of an image projection device;

FIG. 2 is a diagram describing information contained in a focusing lens position table;

FIG. 3A is a diagram showing a configuration of a distance measurement unit;

FIG. 3B is a diagram for describing a distance image captured by a distance measurement unit;

FIG. 4 is a diagram describing various signals of the distance measurement unit;

FIG. 5 is a block diagram showing an optical configuration of the image projection device;

FIG. 6 is a diagram describing projection of an image by the image projection device;

FIG. 7 is a flow chart showing driving control of a focusing lens of the image projection device;

FIG. 8 is a diagram describing detection of an object in an image indicated by a video signal;

FIG. 9 is a diagram for describing driving of the focusing lens based on the distance to a projection target object;

FIG. 10 is a diagram for describing driving of a zooming lens based on the distance to a projection target object;

FIG. 11 is a flow chart showing driving control of the zooming lens of the image projection device;

FIG. 12A is a diagram for describing a calculation method of a target angle of view of the zooming lens that is driven based on the distance to a projection target object;

FIG. 12B is a diagram for describing the calculation method of a target angle of view of the zooming lens that is driven based on the distance to a projection target object;

FIG. 13A is a diagram for describing another example of the calculation method of a target angle of view of the zooming lens that is driven based on the distance to a projection target object; and

FIG. 13B is a diagram for describing yet another example of the calculation method of a target angle of view of the zooming lens that is driven based on the distance to a projection target object.

### DETAILED DESCRIPTION

Hereinafter, exemplary embodiments will be described in detail with reference to the drawings as appropriate. However, unnecessarily detailed description may be omitted. For example, detailed description of already well-known matters and repeated description of substantially the same structure may be omitted. All of such omissions are intended to facilitate understanding by those skilled in the art by preventing the following description from becoming unnecessarily redundant.

Moreover, the inventor(s) provide(s) the appended drawings and the following description for those skilled in the art to fully understand the present disclosure, and do(es) not intend the subject described in the claims to be limited by the appended drawings and the following description.

### First Exemplary Embodiment

Hereinafter, a configuration and an operation of an image projection device will be described in detail as a first exemplary embodiment with reference to the appended drawings.

(1-1. Configuration)

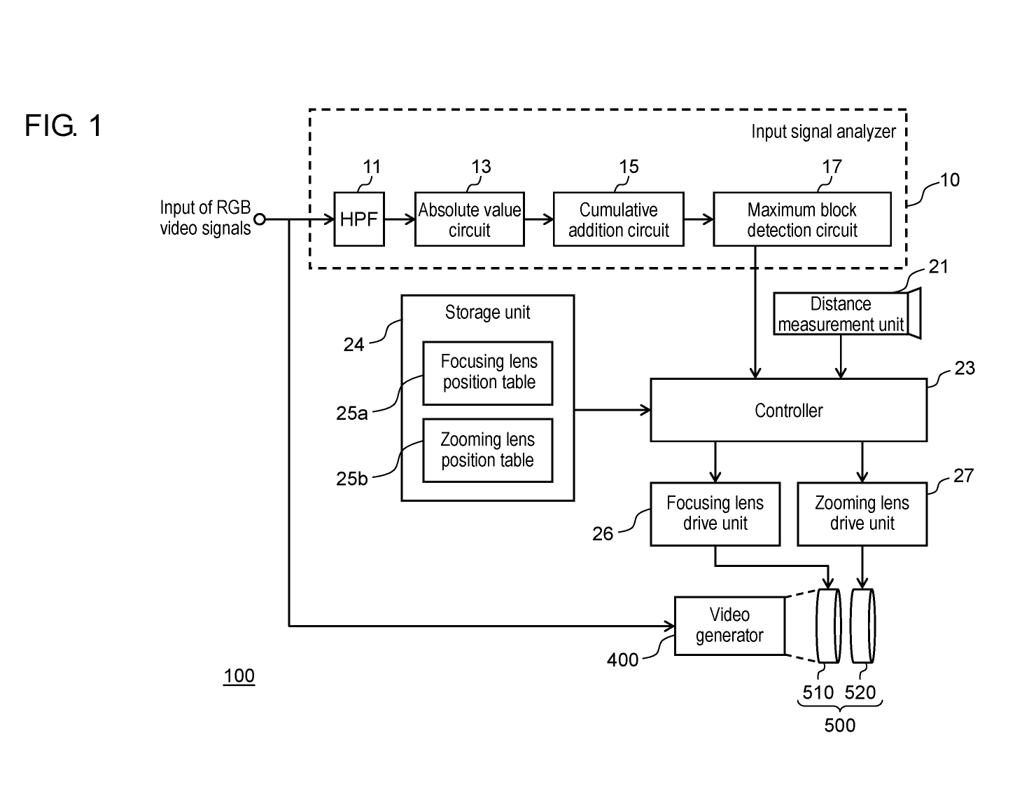

FIG. 1 is a block diagram showing an electrical configuration regarding lens control of image projection device 100. Image projection device 100 includes input signal analyzer 10, distance measurement unit 21, controller 23, storage unit 24, focusing lens drive unit 26, and zooming lens drive unit 27.

Input signal analyzer 10 is a circuit for detecting an object included in one frame image indicated by a video signal (RGB signal). The video signal indicates a signal of a video to be projected by image projection device 100 onto a projection target. Input signal analyzer 10 may input the video signal by reading the signal from a memory provided to image projection device 100, or may supply the signal from another appliance by wireless or wired communication.

Input signal analyzer 10 includes HPF (High pass filter) 11, absolute value circuit 13, cumulative addition circuit 15, and maximum block detection circuit 17. HPF 11 blocks low-frequency components, of a video signal, at or below a predetermined frequency, and passes high-frequency components. Absolute value circuit 13 calculates the amplitude of the video signal which has passed through HPF 11. Cumulative addition circuit 15 cumulatively adds the calculated amplitude. The processes described above are performed for each of a plurality of blocks obtained by dividing the entire area of an image indicated by the video signal. Maximum block detection circuit 17 detects, out of the plurality of blocks forming the image, a block whose value obtained by cumulative addition by cumulative addition circuit 15 is the largest.

Controller 23 controls the operation of the entire image projection device 100. For example, controller 23 controls image processing on an input video signal, driving of projection optical unit 500, such as a zooming lens, a focusing lens, and the like, and an operation of a light source. That is, controller 23 controls a focusing lens, which is projection optical unit 500, so that an object is focused on a projection target object. Alternatively, controller 23 controls a zooming lens, which is projection optical unit 500, so that an object has an appropriate size when projected on a projection target object. Controller 23 may be configured only by hardware, or may be realized by a combination of hardware and software. For example, controller 23 may be configured by a semiconductor integrated circuit called a CPU, an MPU, or the like.

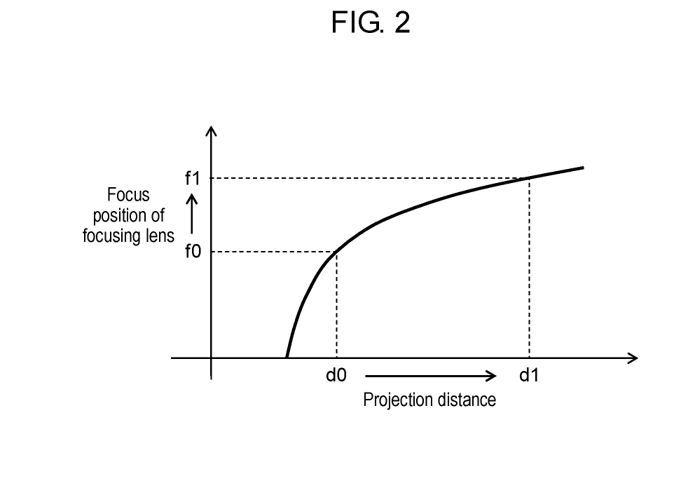

Storage unit 24 stores focusing lens position table 25a and zooming lens position table 25b. Storage unit 24 is configured by a semiconductor storage device such as a flash memory or an SSD, or a storage device such as an HDD. There is a relationship as shown in FIG. 2 between a projection distance, which is a distance from image projection device 100 to a projection target object, and the position of focusing lens 510 for focusing on the projection target object. Focusing lens position table 25a is a table managing, in association with each other, the projection distance and the position of focusing lens 510 for focusing on the projection target object. Zooming lens position table 25b is a table managing, in association with each other, the angle of view for zooming and the position of zooming lens 520 for realizing the angle of view.

In the present exemplary embodiment, a semiconductor storage device or a storage device storing focusing lens position table 25a and zooming lens position table 25b is illustrated as an example of storage unit 24, but storage unit 24 is not limited thereto. That is, it is also possible to store only data of a plurality of points in each table, and to calculate data corresponding to the table by interpolating the points. Alternatively, a relational expression indicating the correspondence relationship corresponding to focusing lens position table 25a or zooming lens position table 25b may be stored, and data corresponding to the table may be obtained by calculating the relational expression as necessary.

Distance measurement unit 21 is a sensor for linearly detecting the distance to a facing object, and is configured, for example, by a TOF (Time-of-Flight) sensor. For example, when facing a wall, distance measurement unit 21 detects the distance from distance measurement unit 21 to the wall, and when facing a table, distance measurement unit 21 detects the distance from distance measurement unit 21 to the table.

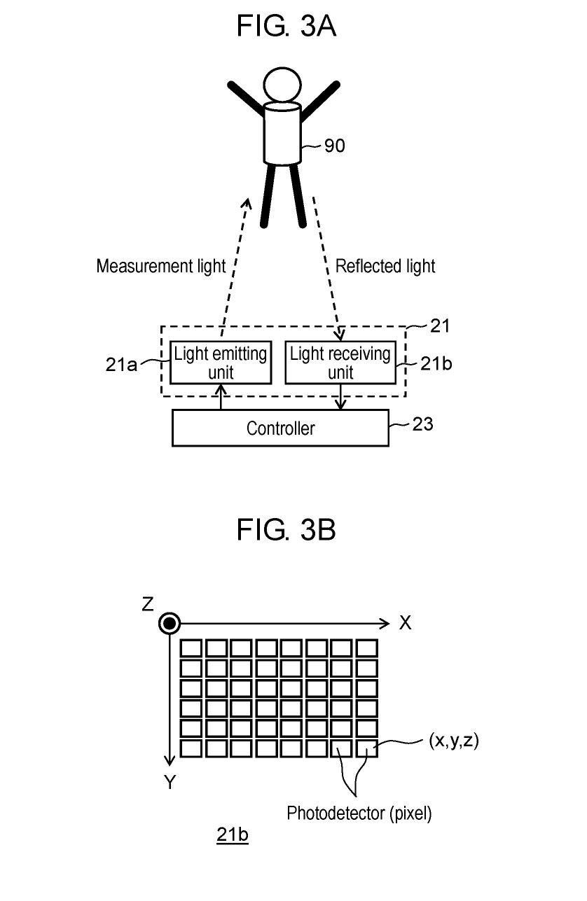

FIG. 3A is a block diagram showing an electrical configuration of distance measurement unit 21. As shown in FIG. 3A, distance measurement unit 21 is configured by light emitting unit 21a for radiating detection light, and light receiving unit 21b for receiving detection light reflected by a facing object. Light emitting unit 21a radiates detection light through an opening in such a way that the light is diffused over a predetermined radiation range. For example, light emitting unit 21a outputs infrared light having a wavelength ranging from 800 nm to 900 nm as detection light. Light receiving unit 21b includes an imaging surface where a plurality of pixels are two-dimensionally arranged. Controller 23 stores the phase of detection light radiated by light emitting unit 21a in storage unit 24. In the case where the facing object is inclined or shaped and points on the surface of the object are not at the same distance from distance measurement unit 21, the plurality of pixels arranged on the imaging surface of light receiving unit 21b receive the reflected light at different timings, and thus the phase of the detection light received by light receiving unit 21b is different for each pixel. Controller 23 stores the phase of the detection light received by light receiving unit 21b at each pixel in storage unit 24.

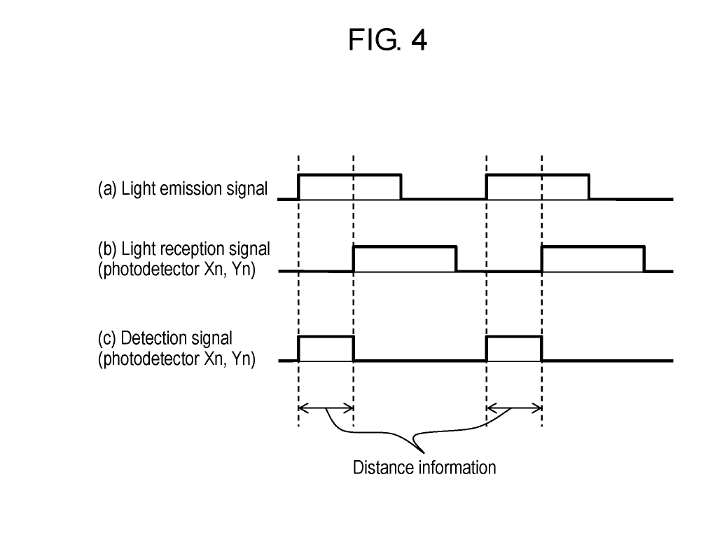

FIG. 4 shows a light emission signal (detection light) transmitted from light emitting unit 21a of distance measurement unit 21, a light reception signal output from light receiving unit 21b based on received reflected light, and a detection signal generated by controller 23. Controller 23 reads, from storage unit 24, the phase of the signal of the light radiated by light emitting unit 21a (detection light) and the phase of the signal of the light received by each pixel of light receiving unit 21b (reflected infrared detection light), and measures the distance to the facing object from distance measurement unit 21 based on the phase difference. Controller 23 generates a distance image (distance information) based on the measured distance.

FIG. 3B is a diagram for describing the distance information acquired by distance measurement unit 21 (light receiving unit 21b). Distance measurement unit 21 performs measurement for each one of pixels corresponding to a detection timing of the received detection light. Controller 23 may obtain a distance detection result for the entire angle of view on a per pixel basis based on the light emission timing of light emitting unit 21a and the detection timing of light receiving unit 21b. As shown in FIG. 3B, in the following description, the X axis indicates the horizontal direction of a distance image, and the Y axis indicates the vertical direction. Moreover, the Z axis indicates the detected distance information. Controller 23 acquires the coordinates (x, y, z) of three X, Y, and Z axes, for each pixel forming the distance image, based on the detection result of distance measurement unit 21. That is, controller 23 may acquire the distance information based on the detection result of distance measurement unit 21, and may specify the projection position of the object.

In the present exemplary embodiment, a TOF sensor is cited as an example of distance measurement unit 21, but distance measurement unit 21 is not limited thereto. That is, distance measurement unit may project a known pattern such as a random dot pattern and calculate the distance based on the shift in the pattern, or may use the parallax of a stereo camera.

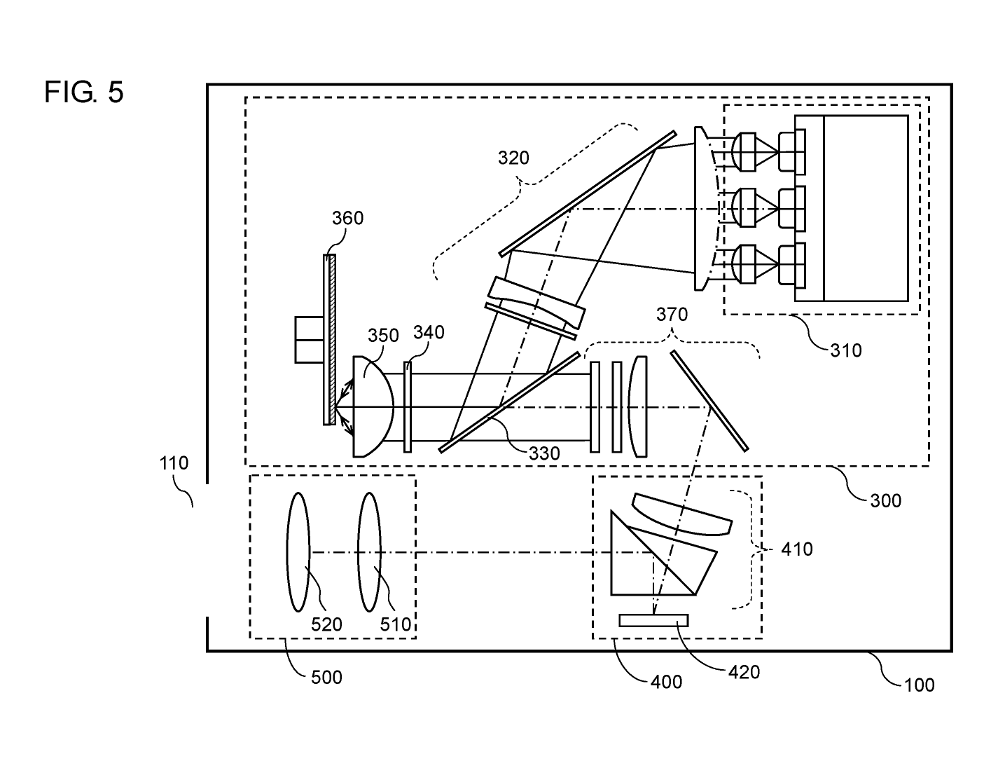

Next, an optical configuration of image projection device 100 will be described with reference to FIG. 5. Image projection device 100 includes light source unit 300, video generator 400, and projection optical unit 500. Light source unit 300 supplies light that is necessary for generation of a projection image to video generator 400. Video generator 400 supplies a generated video to projection optical unit 500. Projection optical unit 500 performs optical transformation such as focusing or zooming on the video supplied by video generator 400. Projection optical unit 500 faces opening 110, and the video is projected from opening 110. That is, a projector including light source unit 300 and video generator 400 projects an image that is based on a video signal through projection optical unit 500.

First, the configuration of light source unit 300 will be described. As shown in FIG. 5, light source unit 300 includes semiconductor laser 310, dichroic mirror 330, λ/4 plate 340, phosphor wheel 360, and the like.

Semiconductor laser 310 is a solid light source that emits S-polarized blue light having a wavelength ranging from 440 nm to 455 nm, for example. The S-polarized blue light emitted from semiconductor laser 310 enters dichroic mirror 330 via light guiding optical system 320.

For example, dichroic mirror 330 has a high reflectance of 98% or more for the S-polarized blue light having a wavelength ranging from 440 nm to 455 nm, but has a high transmittance of 95% or more for P-polarized blue light having a wavelength ranging from 440 nm to 455 nm and green to red light having a wavelength ranging from 490 nm to 700 nm regardless of the polarization state. Dichroic mirror 330 reflects the S-polarized blue light emitted by semiconductor laser 310 in the direction of λ/4 plate 340.

λ/4 plate 340 is a polarizer for converting linear polarization into circular polarization, or for converting circular polarization into linear polarization. λ/4 plate 340 is disposed between dichroic mirror 330 and phosphor wheel 360. S-polarized blue light which has entered λ/4 plate 340 is converted into blue light of circular polarization, and is radiated on phosphor wheel 360 through lens 350.

Phosphor wheel 360 is a flat aluminum plate that is capable of rotating at a high speed. A plurality of B regions which are regions of diffusely reflecting surfaces, G regions where phosphor that emits green light is applied, and R regions where phosphor that emits red light is applied are formed on the surface of phosphor wheel 360. The circular-polarized blue light radiated on the B region of phosphor wheel 360 is diffusely reflected, and enters λ/4 plate 340 again as circular-polarized blue light. The circular-polarized blue light which has entered λ/4 plate 340 is converted into P-polarized blue light, and enters dichroic mirror 330 again. The blue light entering dichroic mirror 330 at this time is P-polarized, and thus the light passes through dichroic mirror 330, and enters video generator 400 via light guiding optical system 370.

Blue light that is radiated on the G region or the R region of phosphor wheel 360 excites the phosphor applied on the G region or the R region, and causes green light or red light to be emitted. The green light or the red light emitted from the G region or the R region enters dichroic mirror 330. The green light or the red light entering dichroic mirror 330 at this time passes through dichroic mirror 330, and enters video generator 400 via light guiding optical system 370.

Since phosphor wheel 360 is rotating at a high speed, blue light, green light, and red light are emitted from light source unit 300 to video generator 400 in a time-division manner.

Video generator 400 generates a projection image according to an input video signal. Video generator 400 includes DMD (Digital-Mirror-Device) 420 and the like. DMD 420 is a display device having a large number of micromirrors arranged on the flat surface. DMD 420 deflects each of the arranged micromirrors according to the input video signal, and spatially modulates the entering light. Light source unit 300 emits blue light, green light, and red light to video generator 400 in a time-division manner. DMD 420 repeatedly receives, via light guiding optical system 410, blue light, green light, and red light which are emitted in a time-division manner. DMD 420 deflects each micromirror in synchronization with the timing of emission of light of each color. DMD 420 deflects the micromirrors according to the video signal to light that proceeds to the projection optical unit and light that proceeds outside the effective coverage of the projection optical unit. Video generator 400 may thereby generate a projection image according to the video signal, and supply the generated projection image to projection optical unit 500.

Projection optical unit 500 includes optical members such as zooming lens 520 and focusing lens 510. Projection optical unit 500 magnifies the video indicated by the light entering from video generator 400, and projects the magnified video on a projection surface. Controller 23 may control, by adjusting the position of zooming lens 520, the projection area for a projection target in such a way that a desired zoom magnification factor is achieved. Controller 23 may magnify the projection video on the projection surface by increasing the zoom magnification factor. At this time, controller 23 widens the projection region by moving the position of zooming lens 520 in the direction of increasing the angle of view (to the wide side). On the other hand, controller 23 may make the projection video on the projection surface smaller by reducing the zoom magnification factor. At this time, controller 23 narrows the projection region by moving the position of zooming lens 520 in the direction of reducing the angle of view (to the tele side). Moreover, controller 23 may focus the projection video by adjusting the position of focusing lens 510 based on predetermined zoom tracking data so as to follow the movement of zooming lens 520.

In the present exemplary embodiment, the configuration of an image projection device of a DLP (Digital-Light-Processing) method using DMD 420 is described as an example, but the configuration is not limited thereto. That is, the image projection device may alternatively adopt a configuration employing a liquid crystal system.

Also, in the description given above, the configuration of an image projection device employing a single panel system in which a light source using a phosphor wheel is used in a time-division manner is described as an example, but the configuration of the image projection device is not limited thereto. That is, the image projection device may adopt a configuration employing a three light source system in which light sources for blue light, green light, and red light are provided, or may adopt a configuration employing a three panel system in which a DMD is provided for each of colors R, G, and B.

Moreover, in the description given above, a configuration is described in which the light source for blue light for generating a projection video and a light source for infrared light for measuring the distance are separate units, but the configuration of light sources is not limited thereto. That is, a light source unit combining the light source for blue light for generating a projection video and a light source for infrared light for measuring the distance may alternatively be used. Furthermore, in the case of adopting the three light source system, a light source unit combining the light sources for red, blue, and green colors and a light source for infrared light may be used.

(1-2. Operation)

(1-2-1. Focusing Lens Control)

An operation of image projection device 100 configured in the above manner will be described below. Image projection device 100 of the present exemplary embodiment detects an object in a video signal, and controls the position of projection optical unit 500 (focusing lens 510, zooming lens 520) according to the distance to the projection target object on which the detected object is to be projected.

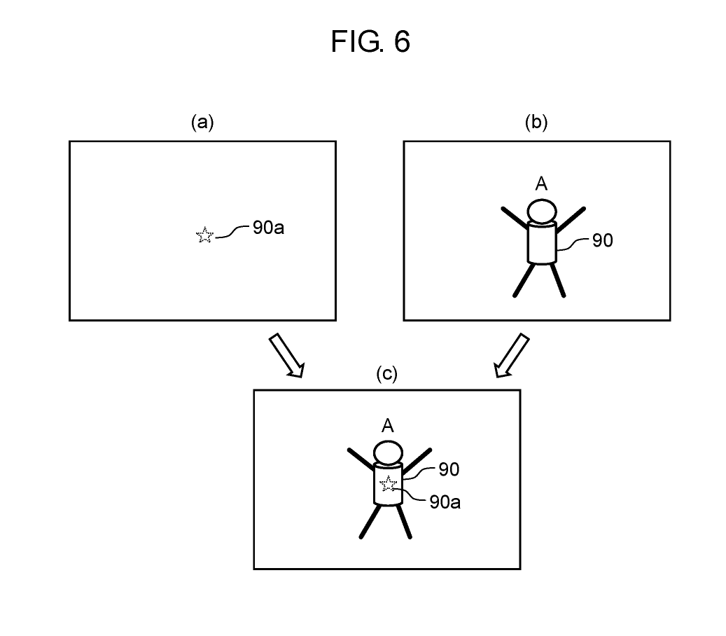

For example, a case is assumed where image projection device 100 projects an image including object 90a as shown in (a) of FIG. 6 on person 90 present at position A (see (b) of FIG. 6) in the manner shown in (c) of FIG. 6. At this time, image projection device 100 detects object 90a from an input video signal, and drives focusing lens 510 based on the distance between person 90, as the target on which detected object 90a is to be projected, and image projection device 100 so that object 90a will be focused on person 90. By driving focusing lens 510 according to the distance between image projection device 100 and a projection target object on which object 90a included in a video signal is to be projected in the above manner, projection may be performed in a state where object 90a is focused on the projection target object.

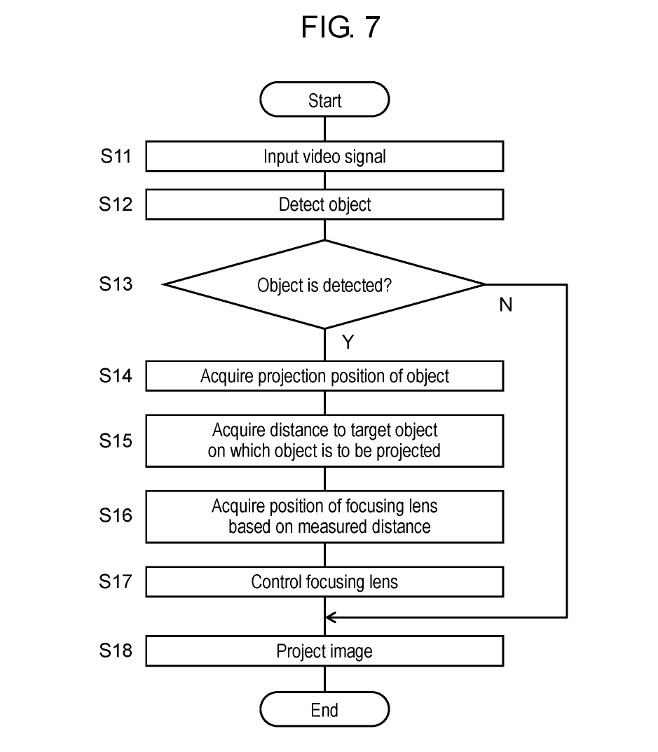

In the following, such an operation of image projection device 100 will be specifically described with reference to FIG. 7. FIG. 7 is a flow chart describing focusing lens control by image projection device 100. Additionally, the flow chart in FIG. 7 indicates an operation for one frame of an input signal, and the processing shown in FIG. 7 is repeated for each frame.

Image projection device 100 inputs a video signal on a per frame basis (S11). Input signal analyzer 10 analyzes the input video signal, and detects, from the image indicated by the video signal, an object satisfying a predetermined condition (an object, in the video to be projected on a projection target object, whose focused state is to be maintained) (S12). The process for detecting the object will now be described.

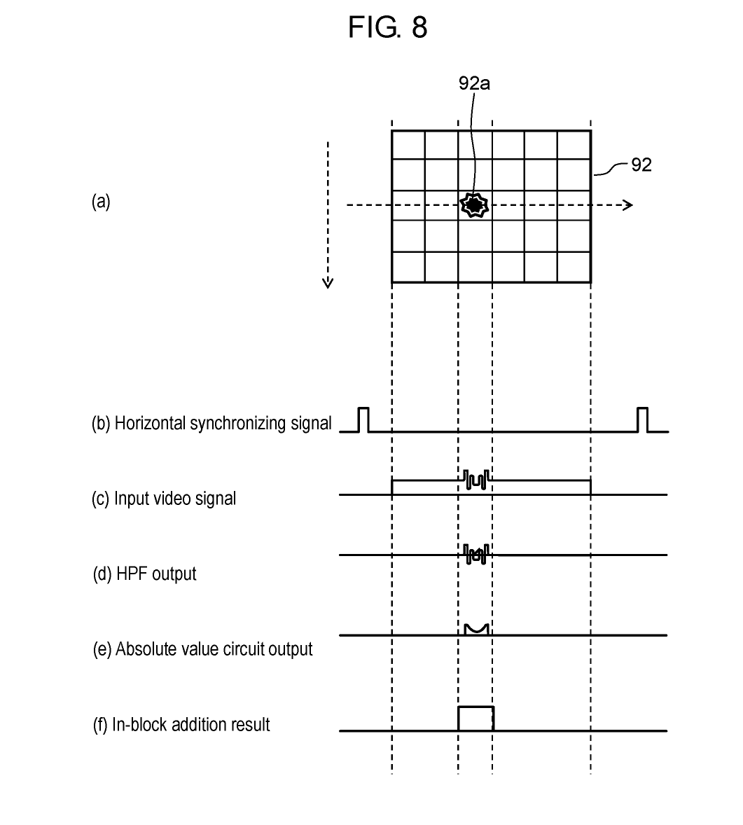

As shown in (a) of FIG. 8, input signal analyzer 10 two-dimensionally divides the region of image 92 in one frame indicated by the video signal into a plurality of blocks of a predetermined size, and detects object 92a in a unit of block. The blocks are two-dimensionally arranged in the image region (horizontal direction x (row direction), vertical direction y (column direction)), and object 92a is detected for each row of blocks. The object is detected based on high-frequency components of the video signal. In the following, one period of a horizontal synchronizing signal will be described as shown in (b) of FIG. 8.

First, a video signal (see (c) of FIG. 8) is input to HPF 11, and high-frequency components are extracted. An output signal of HPF 11 (see (d) of FIG. 8) is input to absolute value circuit 13, and a signal indicating the amplitude value (absolute value) of the output signal is generated (see (e) of FIG. 8). Then, the absolute value is added for each block by cumulative addition circuit 15 (see (f) of FIG. 8). The process described above is performed for each row of blocks in the image. Then, maximum block detection circuit 17 compares the added values calculated for the blocks in the region of the one frame image, and determines the maximum added value. In the case where the maximum added value exceeds a predetermined value, maximum block detection circuit 17 determines that an object is present (detected) in the block with the maximum value. In this manner, input signal analyzer 10 detects a region, in a video signal, including high-frequency components as an object satisfying a predetermined condition.

In the case where no object is detected (NO in S13), controller 23 projects the image based on the video signal without changing focus control (S18).

On the other hand, in the case where an object is detected (YES in S13), controller 23 acquires, based on the position of the block where the object is detected, the position on the projection surface where the detected object is to be projected (S14). For example, controller 23 may acquire, based on the coordinates of one point in the block where the object is detected (for example, the coordinates of the center position), the position of one point of the object on the projection surface, or may acquire, based on the region of the block, the region of the object on the projection surface.

Controller 23 acquires, based on the projection position of the object, the distance to a projection target object that is present at the projection position and where the object is to be projected (S15). Distance information for the projection target object is obtained by controller 23 based on information acquired from distance measurement unit 21. Controller 23 acquires the distance to the projection target object on which the detected object is to be projected, based on the distance information and the position (or the region) of the block where the object is detected. For example, in the case where the position of one point of the object on the projection surface is acquired in step S14, controller 23 acquires the distance to the position. Alternatively, in the case where the region of the object on the projection surface is acquired, controller 23 determines the distances for respective coordinates in the region, and acquires the average value as the distance to the projection target object.

Controller 23 acquires, based on the distance to the projection target object, the position of focusing lens 510 by which the projection light focuses on the projection target object (S16). Specifically, controller 23 may determine the focusing lens position by referring to focusing lens position table 25a.

Controller 23 controls focusing lens drive unit 26 so as to move focusing lens 510 to the determined focusing lens position (S17). Then, controller 23 projects the image based on the video signal (S18).

In the present exemplary embodiment, as the operation of controller 23, in the case where no object is detected (NO in S13), the image based on the video signal is projected without focus control being changed, but this is not restrictive. That is, in the case where no object is detected, controller 23 may determine the projection distances for the entire projection range, acquire the focusing lens position based on the average distance, and control the focusing lens. Alternatively, controller 23 may determine the projection distance at the center of the projection range, and control the focusing lens based on the distance.

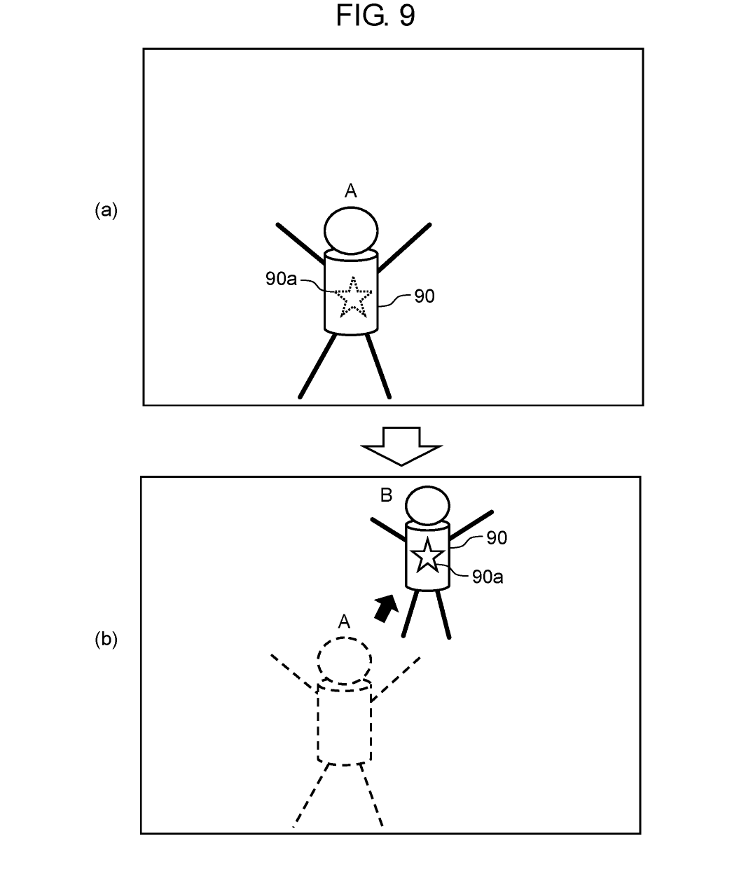

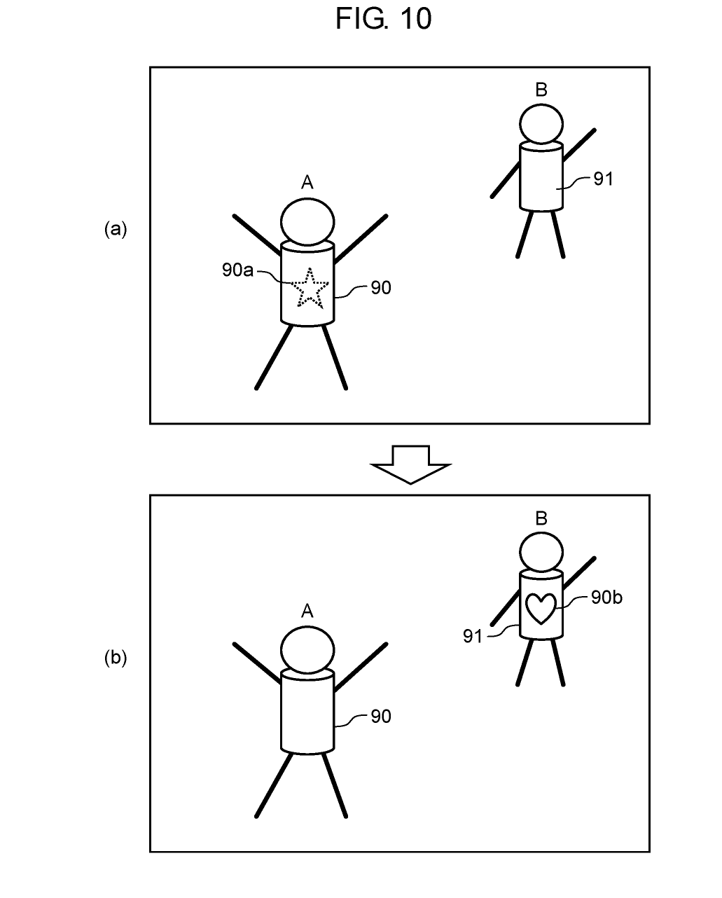

As described above, image projection device 100 analyzes an input video signal, and determines the projection position (display position) of an object to be projected. Then, the distance to the projection target object at the position corresponding to the projection position is determined. The focusing lens is controlled based on the distance to the projection target object. Accordingly, as shown in FIG. 9, for example, even if person 90, i.e., a projection target object, moves from position A to position B, which is different from position A in the optical axis direction, object 90a included in the video indicated by the input signal may be kept focused on person 90. Also, as shown in FIG. 10, even in a case where the input image is switched from a state where object 90a is projected being focused on person 90 at position A ((a) of FIG. 10) to a state where object 90b is to be projected on person 91 at position B which is a position farther away from image projection device 100 than position A, projection may be performed with object 90b focused on person 91.

(1-2-2. Zooming Lens Control)

An example of controlling focusing lens 510 according to the distance to a projection target object has been described above. In the following, an example of controlling zooming lens 520 according to the distance to a projection target object will be described.

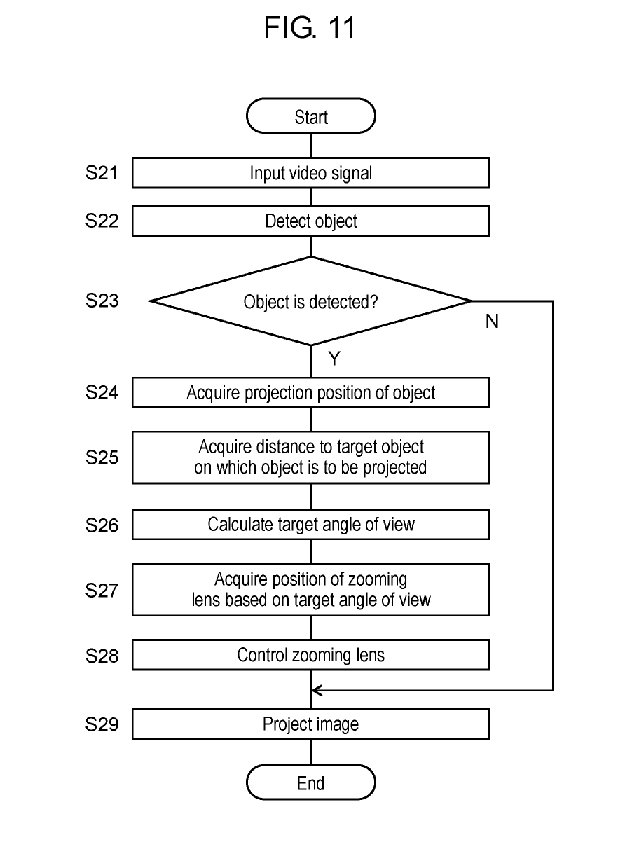

FIG. 11 is a flow chart showing a process at the time of controlling the position of zooming lens 520 based on the position of an object in a video signal.

Image projection device 100 inputs a video signal on a per frame basis (S21). Input signal analyzer 10 analyzes the input video signal, and detects an object (an object to be projected on a projection target object) from the image indicated by the video signal (S22). The process for detecting the object is as described above.

In the case where no object is detected (NO in S23), controller 23 projects the image based on the video signal without changing zooming lens control (S29).

On the other hand, in the case where an object is detected (YES in S23), controller 23 acquires the position on the projection surface of the detected object (S24). Furthermore, controller 23 acquires, based on the projection position of the object, the distance to the projection target object at the projection position (S25). The method for acquiring the position of the object on the projection surface is as described above.

Controller 23 calculates the target angle of view of zooming lens 520 based on the distance to the projection target object (S26). The target angle of view is calculated in the following manner, for example.

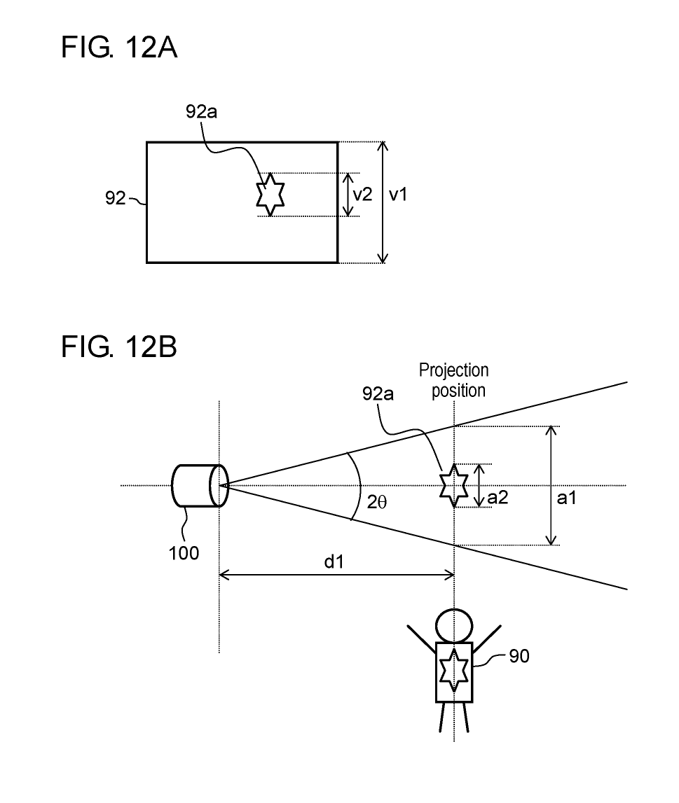

As shown in FIG. 12A, a case where object 92a is included in image 92 indicated by a video signal is assumed. The image size of image 92 indicated by the video signal is denoted by v1, and the image size of object 92a is denoted by v2. Also, as shown in FIG. 12B, the display size of object 92a at the projection position is denoted by a2, and the display size of the entire projection image is denoted by a1. Moreover, the angle of view of the zooming lens is denoted by 2θ, and the distance from projection optical unit 500 of image projection device 100 to person 90, i.e., the projection target object, is denoted by d1. In this case, the following relationships are established.

a1=a2(v1/v2) (Equation 1)

a1=2·d1·tan θ (Equation 2)

Target angle of view 2θ of zooming lens 520 may be determined by the following equation based on the relationships given above.

2θ=2·tan⁻¹{(a2·v1)/(2·d1·v2)} (Equation 3)

At the time of detection of an object during analysis of a video signal, controller 23 acquires size v2 of the object and size v1 of the screen. Also, display size a2 of object 92a at the projection position is obtained in advance by controller 23. Accordingly, controller 23 may calculate target angle of view 2θ based on image size v2 of the object, image size v1 of the screen, display size a2 of object 92a, and Equation 3.

When target angle of view 2θ is determined, controller 23 refers to zooming lens position table 25b, and determines the control target position of zooming lens 520 based on target angle of view 2θ (S27). Controller 23 controls zooming lens drive unit 27 so as to move zooming lens 520 to the determined zooming lens position (S28). Then, controller 23 projects the image based on the video signal (S29).

Zooming lens 520 is controlled in the above manner according to the distance to the projection target object. By such control, object 92a having appropriate display size a2 according to the distance to the projection target object may be projected on person 90.

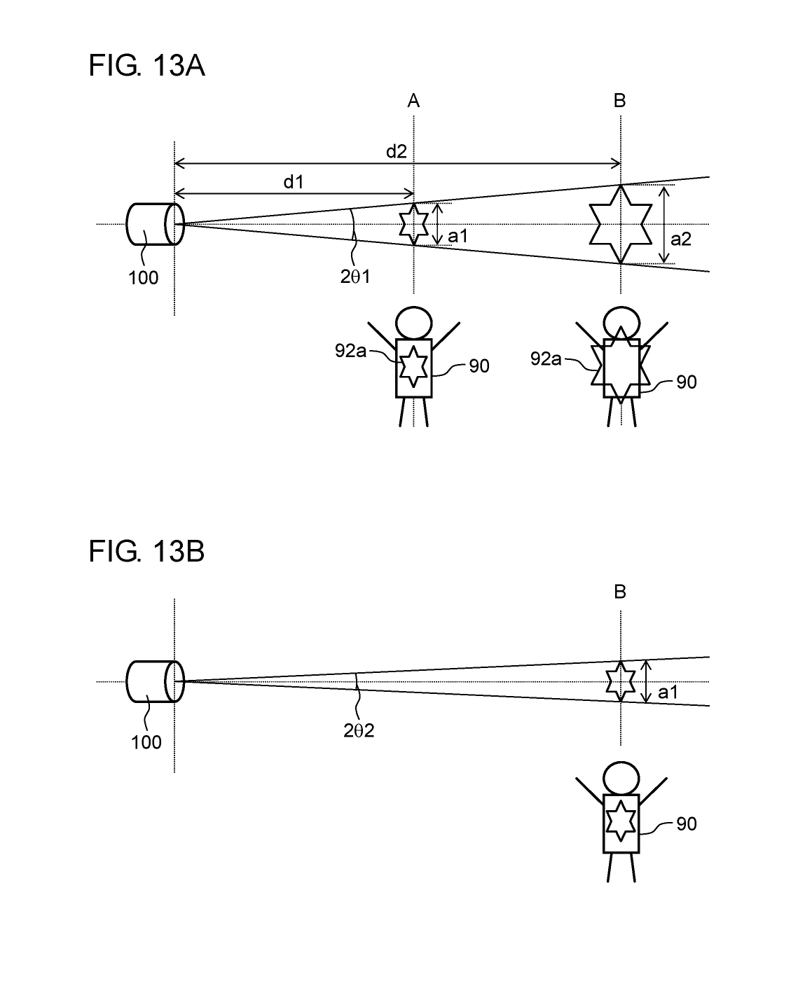

Another example of the calculation method of the target angle of view will be described with reference to FIGS. 13A, and 13B. For example, if person 90, i.e., the projection target object moves from position A to position B (position farther away from image projection device 100), the display size of object 92a is increased from a1 to a2, as shown in FIG. 13A. Accordingly, in the following, an example is described in which, even when the distance between person 90 and image projection device 100 is changed due to movement of person 90, the angle of view for zooming is adjusted so that an object having an appropriate size is projected on person 90.

As shown in FIG. 13A, the display size of object 92a at the projection position A at distance d1 from image projection device 100 is denoted by a1, and in this case, the display size of object 92a which may be projected at a position at distance d2 from image projection device 100 is denoted by a2. Also, the angle of view (target angle of view) of the zooming lens for causing the display size of object 92a at the position at distance d2 from image projection device 100 to be a1 is denoted by 2θ2, as shown in FIG. 13B. In this case, the following relationships are established.

### Based on FIG. 13A,

a1=2·d1·tan θ1 (Equation 4)

a2=2·d2·tan θ1 (Equation 5)

θ1=tan⁻¹{a1/(2·d1)} (Equation 6)

### Based on FIG. 13B,

a1=2·d2·tan θ2 (Equation 7)

2·d1·tan θ1=2·d2·tan θ2 (Equation 8)

tan θ2=(d1/d2)·tan θ1 (Equation 9)

Accordingly, target angle of view 2θ 2 of zooming lens 520 may be determined by the following equation.

2·θ2=2·tan⁻¹l{a1·d1/(2·d2)} (Equation 10)

Controller 23 may determine target angle of view 2θ2 based on display size a1 of object 92a, distance d1 before change, distance d2 after change, and Equation 10.

By controlling zooming lens 520 in this manner, even when person 90 moves and the distance between person 90 and image projection device 100 is changed, the display size of object 92a may be controlled to an appropriate size at the time of projection on person 90. That is, object 92a is displayed such that the proportion of the display size of object 92a to the size of person 90 is not changed. For example, in the case where person 90 has moved toward image projection device 100, zooming lens 520 is adjusted so as to increase the target angle of view. On the other hand, in the case where person 90 has moved away from image projection device 100, zooming lens 520 is adjusted so as to reduce the target angle of view.

(1-3. Effects and the Like)

As described above, image projection device 100 according to the present exemplary embodiment includes projection optical unit 500, light source unit 300 and video generator 400 for projecting an image that is based on a video signal on a projection target object through projection optical unit 500, input signal analyzer 10 for detecting a predetermined object from the image indicated by the video signal, and controller 23 for specifying, based on the position of the detected object in the image, the projection position of the object, and controlling projection optical unit 500 based on the projection position.

As described above, image projection device 100 determines the projection position (display position) of an object from an image indicated by a video signal, and controls projection optical unit 500 based on the projection distance to a projection target object present at the projection position. Accordingly, for example, even in a case where the projection target object has moved, or in a case where the projection target object is a three-dimensional object, an image according to which an object is focused and which has a predetermined size may be projected on the projection target object (see FIGS. 9, 12A, and 12B). Also, in the case where a plurality of projection target objects exist at different distances from image projection device 100, an image according to which an object is focused and which has a predetermined size may be projected on a projection target object on which the object is to be projected (see FIGS. 10, 13A, and 13B).

### OTHER EXEMPLARY EMBODIMENTS

Heretofore, the first exemplary embodiment has been described as an example of the technique disclosed in the present application. However, the technique in the present disclosure is not limited to the above embodiment, and may also be applied to embodiments which have been subjected to modifications, substitutions, additions, or omissions as required. Moreover, it is also possible to combine the structural elements described in the first exemplary embodiment. In the following, other exemplary embodiments will be described as examples.

Image projection device 100 according to the exemplary embodiment described above is an example of an image projection device. Input signal analyzer 10 is an example of a detector for detecting an object. An object may be detected by image analysis by software. Distance measurement unit 21 is an example of a distance detector. Any distance measurement device may be used as long as the distance to a target object at a projection position of an object may be measured.

In the exemplary embodiment described above, in the focusing lens control, the distance to a projection target object is measured by distance measurement unit 21, and the focusing lens is driven to the focus position based on the distance. However, the focusing method is not limited thereto. For example, a focusing operation may be performed by a contrast AF method in which a focusing operation is performed based on a captured image. In this case, image projection device 100 includes an image capturing device for capturing an image, instead of distance measurement unit 21. The image capturing device includes an image sensor such as a CCD or CMOS image sensor, and captures an image including at least a projection region. Controller 23 may specify the region on the captured image corresponding to the position (or the region) of an object detected by input signal analyzer 10 from a video signal, and may control focusing lens 510 so as to focus on the specified region. However, in the case of contrast AF, high-frequency components for detecting a contrast may not be included depending on the image of a region for extracting an AF evaluation value, and focusing may not be finely performed. Accordingly, the first exemplary embodiment is advantageous because focusing on a desired target may be more accurately performed when lens control is performed by actually measuring the distance to the video projection target.

The DMD may be capable of outputting, in addition to R, G, and B images, an image of IR (infrared light). By using such a DMD, the light emitting unit of the TOF sensor of distance measurement unit 21 may be omitted.

Also, the detection method of an object in an image indicated by an input video signal is not limited to the method described above. An object may be detected by other detection methods. For example, a method for detecting an object under the following conditions is conceivable.

(1) Peak brightness value is a predetermined value or more

(2) Average brightness value is a predetermined value or more

(3) Average saturation value is a predetermined value or more

(4) Peak saturation value is a predetermined value or more

The position of a block including an object is detected by determining whether each of the conditions given above is satisfied or not for each of the blocks obtained by dividing one frame image. Specifically, the number of pixels meeting each of the conditions given above is counted for each block, and if the number of counted pixels is a predetermined value or more (for example, 50% or more), the block is determined as including an object (stabilization of detection by removal of isolated points). At this time, it is also possible to detect only an object that is temporally continuous by applying a temporal filter over a plurality of frames after detecting an object in each frame (stabilization of detection).

The focusing lens control shown by the flow chart in FIG. 7 and the zooming lens control indicated by the flow chart in FIG. 11 may be used in combination.

In the exemplary embodiment described above, an example is described where only one object is detected from an image indicated by a video signal, but it is also possible to detect a plurality of objects. In this case, the focusing lens and the zooming lens may be controlled with respect to the projection target object that is the closest to image projection device 100 out of a plurality of projection targets corresponding to the plurality of detected objects.

Heretofore, exemplary embodiments have been described as examples of the technique of the present disclosure. The appended drawings and the detailed description have been provided for this purpose.

Therefore, in order to illustrate the technique described above, the structural elements shown in the appended drawings and described in the detailed description include not only structural elements that are essential for solving the problem but also other structural elements. Hence, even if these non-essential structural elements are shown in the appended drawings and described in the detailed description, these structural elements should not be immediately recognized as being essential.

Furthermore, the exemplary embodiments described above are for illustrating the technique of the present disclosure, and thus various modifications, substitutions, additions, and omissions may be performed within a range of claims and equivalents to the claims.

The present disclosure may be applied to an image projection device for projecting and displaying an image on a target object.

What is claimed is:

1. An image projection device comprising:
a projection optical unit;
a projector for projecting an image that is based on a video signal on a projection target object through the projection optical unit;
a detector for detecting a predetermined object from the image indicated by the video signal; and
a controller for specifying, based on a position of the detected object in the image, a projection position of the object, and controlling the projection optical unit based on the projection position.

2. The image projection device according to claim 1, further comprising a distance detector for detecting a distance to the projection target object,
wherein the controller specifies the projection position of the object based on the position of the detected object in the image and a detection result of the distance detector.

3. The image projection device according to claim 2,
wherein the projection optical unit includes a focusing lens, and
the controller controls the focusing lens such that the object is focused on the projection target object.

4. The image projection device according to claim 2,
wherein the projection optical unit includes a zooming lens, and
the controller controls the zooming lens such that the object has an appropriate size when projected on the projection target object.

5. The image projection device according to claim 1, wherein the detector detects the object based on a high-frequency component of the image indicated by the video signal.
